(19) United States
(12) Patent Application Publication
(10) Pub. No.: US 2007/0025225 A1
(43) Pub. Date: Feb. 1, 2007

(54) INFORMATION STORAGE MEDIUM, INFORMATION RECORDING/REPRODUCING APPARATUS AND INFORMATION RECORDING/REPRODUCING METHOD

(75) Inventor: Takayuki MORI, Hachioji-Shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-Ku (JP)

(21) Appl. No.: 11/459,551

(22) Filed: Jul. 24, 2006

(30) Foreign Application Priority Data
Jul. 28, 2005 (JP) 2005-219609

(51) Int. Cl. G11B 3/74

(52) U.S. Cl. 369/94

(57) ABSTRACT

An information storage medium on which characters, images, etc., can be optically formed with high visual distinguishability. In the information storage medium for allowing multilayer recording with a laser-emitted face on one side and a label face on the other side, the information storage medium includes: a first recording layer for optically recording various kinds of digital data from the laser-emitted face side; and a second recording layer for optically recording image data from the laser-emitted face side and allowing visual confirmation from the label face side.

### BACKGROUND OF THE INVENTION

1. Field of the Invention

The present invention relates to an information storage medium, an information recording/reproducing apparatus, and a method of recording/reproducing information. More particularly, the present invention relates to an information storage medium, an information recording/reproducing apparatus, and a method of recording/reproducing information which are capable of recording and reproducing a visible image.

2. Description of the Related Art

Optical discs (information storage media), such as various kinds of CD and DVD, etc., have become widespread today. Also, new next-generation DVDs, for example HD DVD, etc., have been developed. These optical discs include many types of optical disc on which user can write data arbitrarily, such as recordable optical discs, rewritable optical discs, etc.

In general, an optical disc includes a recording face on which a laser beam is emitted on one side and a label face on the opposite side. The information identifying the optical disc is stuck onto the label face, for example by being printed on paper.

Also, in the case of a recordable disc or a rewritable disc, in order to identify the contents of recorded data, a user himself/herself often writes the contents of the data on a stuck label, such as paper, etc., with a felt-tip pen, etc., for example. Alternatively, the user often sticks an identification label printed by himself/herself. In the case of a rewritable disc, recording contents on the disc can be rewritten any number of times, and thus it often happens that the user writes the identification information in accordance with the contents of recording data for each time of rewriting, or the user needs to unstick a paper label, etc., and stick a new label, etc., once again. This work is not only troublesome, but sometimes brings about mistaken information written on the label. Also, if the recording of a label is neglected because of the troublesomeness, it requires a lot of work to search and identify the contents recorded on the optical disc later.

If it is possible to optically record characters and images which allow a user to visually confirm the data contents easily on the optical disc at the same time of recording data onto an optical disc by an easy method, the burden on the user is greatly relieved. Also, in the case of CD-ROMs, DVD-ROMs, etc., that cannot be rewritten by a user, it becomes possible for an optical-disc supplier to eliminate a label sticking step, and thus to reduce the production cost of the optical disc.

On the other hand, for CDs, a technique for optically drawing characters and images in an area on which data is not recorded on a recording face has been disclosed, for example in JP 2004-171605 A and JP 2004-213852 A, etc.

JP 2004-171605 A has disclosed a technique for generating a diffraction grating by forming a periodic pit on an optical disc in order to generate a hologram image. Also, JP 2004-213852 A has disclosed a technique for forming visible images, such as characters, designs, etc., by emitting a laser beam onto an unrecorded area in order to give a thermal change in color.

The technique disclosed in JP 2004-171605 A, etc., is to form an image in an unrecorded area of a data recording layer, and there is much room for improvement in terms of visibility. Also, it is possible to allocate a relatively wide area to an unrecorded area on a CD. However, on a DVD, there is a small degree of freedom for an unrecorded area, and thus, it is not easy to allocate a wide area to an image-drawing area.

Furthermore, in the technique disclosed in JP 2004-171605 A, etc., recorded images are visually confirmed from the recording face side. From the viewpoint of the user, it is preferable to visually confirm the images from the label face side at once. Thus, there is also much room for improvement from this point.

### SUMMARY OF THE INVENTION

The present invention has been made in view of the above-described circumstances. It is an object of the present invention to provide an information storage medium, an information recording/reproducing apparatus, and a method of recording/reproducing information which are capable of optically forming characters, images, etc., with high visual distinguishability.

In order to solve the above-described problems, according to an embodiment of the present invention, there is provided an information storage medium for allowing multilayer recording with a laser-emitted face on one side and a label face on the other side, the information storage medium including: a first recording layer for optically recording various kinds of digital data from the laser-emitted face side; and a second recording layer for optically recording image data from the laser-emitted face side and allowing visual confirmation from the label face side.

Also, in order to solve the above-described problems, according to another embodiment of the present invention, there is provided an information recording/reproducing apparatus for recording and reproducing information onto and from an information storage medium allowing multilayer recording with a laser-emitted face on one side and a label face on the other side, the information recording/reproducing apparatus including: means for optically recording and reproducing various kinds of digital data onto and from a first recording layer from the laser-emitted face side; and means for optically recording image data onto a second recording layer from the laser-emitted face side and allowing visual confirmation from the label face side.

Also, in order to solve the above-described problems, according to another embodiment of the present invention, there is provided a method of recording onto and reproducing from an information storage medium allowing multilayer recording with a laser-emitted face on one side and a label face on the other side, the method including the steps of: optically recording and reproducing various kinds of digital data onto and from a first recording layer from the laser-emitted face side; and optically recording image data onto a second recording layer from the laser-emitted face side and allowing visual confirmation from the label face side.

The present invention enables the user to optically form characters, images, etc., on an information storage medium with high distinguishability.

### BRIEF DESCRIPTION OF THE DRAWINGS

FIG. 1 is a schematic diagram illustrating a cross-sectional structure of an information storage medium according to an embodiment of the present invention;

FIGS. 2A to 2C are schematic diagrams illustrating a recording structure of an information storage medium according to an embodiment of the present invention;

FIG. 3 is a first diagram illustrating the concept of image drawing according to an embodiment of the present invention;

FIGS. 4A to 4C are second diagrams illustrating the concept of drawing an image according to an embodiment of the present invention;

FIGS. 5A and 5B are third diagrams illustrating the concept of drawing an image according to an embodiment of the present invention; and

FIG. 6 is a diagram illustrating an example of a system configuration according to an embodiment of the present invention.

### DESCRIPTION OF THE PREFERRED EMBODIMENTS

A description will be given of an information storage medium, an information recording/reproducing apparatus, and a method of recording/reproducing information according to an embodiment of the present invention with reference to the drawings.

1. Information Storage Medium

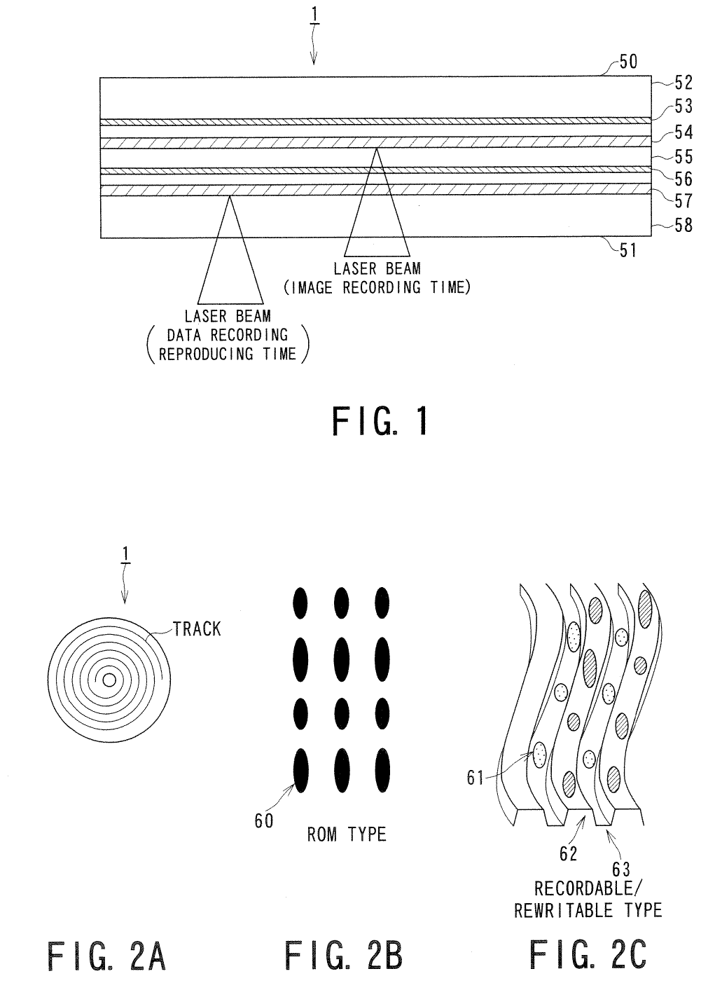

FIG. 1 is a schematic diagram illustrating the cross-sectional structure of an information storage medium 1 according to an embodiment. The information storage medium 1 is a so-called optical disc, such as a CD, a DVD, etc. Also, the information storage medium 1 includes a next-generation DVD, that is to say, an HD DVD.

The information storage medium 1 includes a ROM type (CD-ROM, DVD-ROM, etc.), which does not allow the user to change the data that has already been written by a disc supplier, a recordable type (CD-R, DVD-R, HD DVD-R, etc.), which allows the user to write data only once, and a rewritable type (CD-RW, DVD-RAM, HD DVD-RW, etc.), which allows the user to rewrite data many times (within a predetermined limit number of times), and the like.

The information storage medium 1 has a multilayer structure having at least two layers or more. An example shown in FIG. 1 is the information storage medium 1 having a dual-layer structure.

In FIG. 1, the information storage medium 1 has a laser-emitted face 51 on which a laser beam is emitted at the lowermost, and a label face 50 at the uppermost.

The information storage medium 1 has a laminated structure including, from the lower side, a disc substrate (cover layer) 58, a first recording layer 57, a first reflective layer 56, an intermediate layer 55, a second recording layer 54, a second reflective layer 53, and a disc substrate 52.

The disc substrate (cover layer) 58 is a layer having a face (laser-emitted face 51) opposed to an optical pickup, and is constituted so as to allow the transmission of the laser beam emitted from the optical pickup.

Various kinds of digital data (various kinds of content data, such as video, audio, etc., and various kinds of information processing data, etc.) is optically recorded onto and reproduced from the first recording layer 57.

The second recording layer 54 is a layer on which image data, such as characters, graphics, photographs, etc., are drawn to allow visual confirmation. The method of drawing images is optical recording by a laser beam in the same manner as the first recording layer 57.

The first reflective layer 56 and the second reflective layer 53 are the layers for efficiently reflecting a laser beam to the optical pickup when information is recorded onto and reproduced from the first recording layer 57 and the second recording layer 54, respectively. The intermediate layer 55 is disposed between the first reflective layer 56 and the second recording layer 54.

In a known information storage medium, the recording capacity of a disc is designed to be increased by recording various kinds of digital data on multiple recording layers (in the example of FIG. 1, the first recording layer 57 and the second recording layer 54).

When digital data is recorded onto and reproduced from the first recording layer 57, focus control is performed such that the focus position of a laser beam is placed on the first recording layer 57 (the left-side position of a laser beam in FIG. 1). On the other hand, when digital data is recorded onto and reproduced from the second recording layer 54, focus control is performed such that the focus position of a laser beam is placed on the second recording layer 54 (the right-side position of a laser beam in FIG. 1). At the time of recording onto and reproducing from the second recording layer 54, the focus position is shifted (defocused) from the focus position of the first recording layer 57 in order not to be influenced by the first recording layer 57.

In the present embodiment, the first recording layer 57 is used for recording and reproducing digital data, and the second recording layer 54 is used for drawing image data. The image data drawn on the second recording layer 54 includes, for example characters, graphics, photographs, etc., for making it easy to identify the contents of the digital data recorded on the first recording layer 57. It is possible for the user to easily identify the contents of the digital data recorded on the information storage medium 1 by the visual image formed on the second recording layer 54.

FIGS. 2A to 2C are diagrams illustrating the recording structure of a general optical disc. The information storage medium 1 according to the present embodiment has the same recording structure as the recording structure shown in FIGS. 2A to 2C.

As shown in FIG. 2A, the information storage medium 1 has a spiral track. The digital data to be recorded on the first recording layer 57 is recorded along this track. Also, the image data to be recorded (drawn) on the second recording layer 54 is recorded along this track in the same manner as the first recording layer 57.

Pits are formed along the track, and digital data is reproduced by the difference of the reflection factors caused by the existence of the pits.

FIG. 2B is a diagram illustrating the state of typical pits of the information storage medium 1 of a ROM type. The pits are formed on a substantially flat surface.

FIG. 2C is a diagram illustrating the state of typical pits of the information storage medium 1 of a recordable type or a rewritable type. On the information storage medium 1 of a recordable type or a rewritable type, grooves 63 are formed on a planar land 62. The grooves 63 are formed along the track with a wobbling waveform. The pits 61 can be formed either on the lands 62 or the grooves 63, or on both of them.

In the present invention, the method of drawing images itself is not limited, and thus the techniques disclosed in JP 2004-171605 A and JP 2004-213852 A, etc., may be used for the method of drawing images. For example, when image data is drawn on the second recording layer 54, the settings, such as the existence of pits, the distance of pits, the size of a pit (length of a pit in the track direction), etc., are determined in accordance with an image to be drawn. A pit area and an area other than a pit show different reflection factors, and thus it is possible to form a visible image on the second recording layer 54.

A pit is not necessarily discrete as in the case of recording digital data, and may be in continuous form. Also, dark and light coloring of an image may be expressed by the roughness and fineness of the distance of pits.

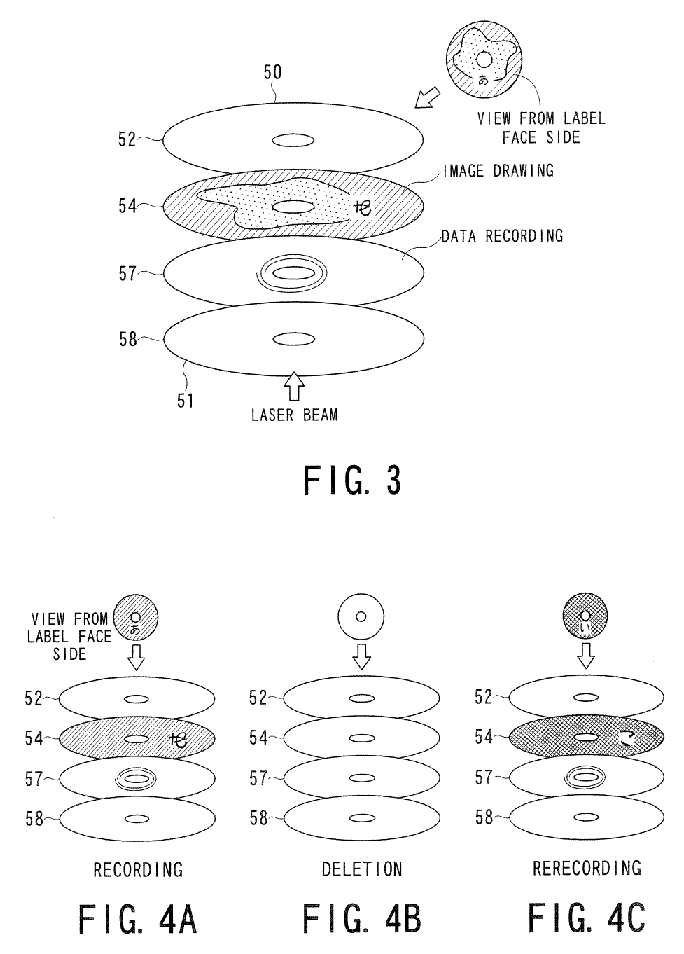

FIG. 3 is a diagram illustrating the concept of forming a visual image in the information storage medium 1 according to the present embodiment. A laser beam is emitted from the laser-emitted face 51 side of the disc substrate (cover layer) 58. The emitted laser beam is transmitted through the first recording layer 57, and the focus position is placed on the second recording layer 54. In this state, an image is formed on the second recording layer 54.

In the present embodiment, the disc substrate (cover layer) 58 and the disc substrate 52 are formed by a transparent material capable of transmitting visible light. Also, the first reflective layer 56 and the second reflective layer 53 are formed to allow transmitting visible light. It is possible to achieve a technique for forming the information storage medium 1 to be transparent (allowing to transmit visible light) using a publicly known technique.

The information storage medium 1 is formed to be transparent, and thus it becomes possible to visually confirm an image drawn on the second recording layer 54 through the disc substrate 52 from the label face 50 with ease.

Also, if the image includes a character as shown in FIG. 3, when the character is drawn by a laser beam from the laser-emitted face 51 side, the character should be formed in mirror writing. If a character is drawn in mirror writing, the view from the label face 50 side can be easily recognized as a normal character by the user.

Digital data may be or may not be recorded on the first recording layer 57.

Also, in the description of the present embodiment, the first recording layer 57 on which digital data is recorded is disposed at a position closer to a laser beam than the second recording layer 54 on which an image is drawn. On the contrary, the second recording layer 54 may be disposed at a position closer to a laser beam than the first recording layer 57.

FIGS. 4A to 4C are diagrams illustrating the concept of drawing an image when the information storage medium 1 is a recordable type or a rewritable type.

FIG. 4A shows a view of drawing an image including “A”, which is a Japanese syllabary character equivalent to A in English, in mirror writing on the second recording layer 54. The image drawn on the second recording layer 54 is recognized as the normal character “A” as a view from the label face 50.

FIG. 4B shows a view of having deleted an image on the second recording layer 54. An image can be deleted, for example, by the same method as the deletion of normal digital data.

FIG. 4C shows a situation in which an image different from the image in FIG. 4(a) (an image including “I”, which is another Japanese syllabary character equivalent to I in English, has been drawn in mirror writing) on the second recording layer 54.

By the present embodiment, it is possible to delete an image simultaneously with the deletion of digital data. Also, when different digital data is newly recorded, it is possible to draw a new image capable of showing identification of its contents on the second recording layer 54. Accordingly, it becomes unnecessary to do troublesome work, such as to unstick a paper label and stick a new label again on the label face 50 each time rewriting digital data, etc., as the way it has been done so far, and thus it becomes convenient. Also, it becomes easy to prevent the user from failing in writing the contents on a label, etc. Thus, it is possible to prevent the information storage medium 1 itself and the data recorded on the medium from being scattered and lost.

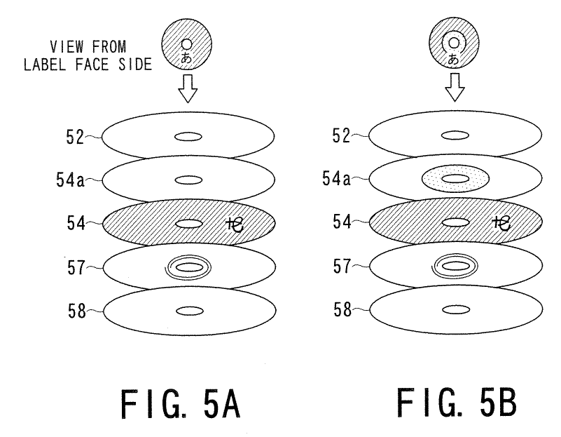

FIG. 5 is a diagram illustrating an example of an embodiment having a plurality of the second recording layers 54.

In the present embodiment, as shown in FIG. 5, for example different images are drawn on the two second recording layers 54 and 54a. Even when a sufficient light/dark ratio cannot be obtained by a single recording layer, it is possible to obtain a wide range of light/dark ratio by individually drawing images on two overlapping recording layers or more, and thus an image having grayscales can be obtained.

Also, it is possible to form an image viewed from the label face 50 to be a color image by forming the second recording layer 54 with a material which changes to a specific color by being irradiated with a laser beam and further by overlapping a plurality of the second recording layers 54a having different colors after the changes in color.

In each of the above-described embodiments, the information storage medium 1 having a transparent structure is visually confirmed from the label face 50 side. On the other hand, the information storage medium 1 often does not have a transparent structure. In this case, an image drawn on the second recording layers 54 should be visually confirmed from the laser-emitted face 51 side. Moreover, if a character is included in the image, a normal character should be drawn rather than in mirror writing.

2. Information Recording/Reproducing Apparatus and Information Recording/Reproducing Method

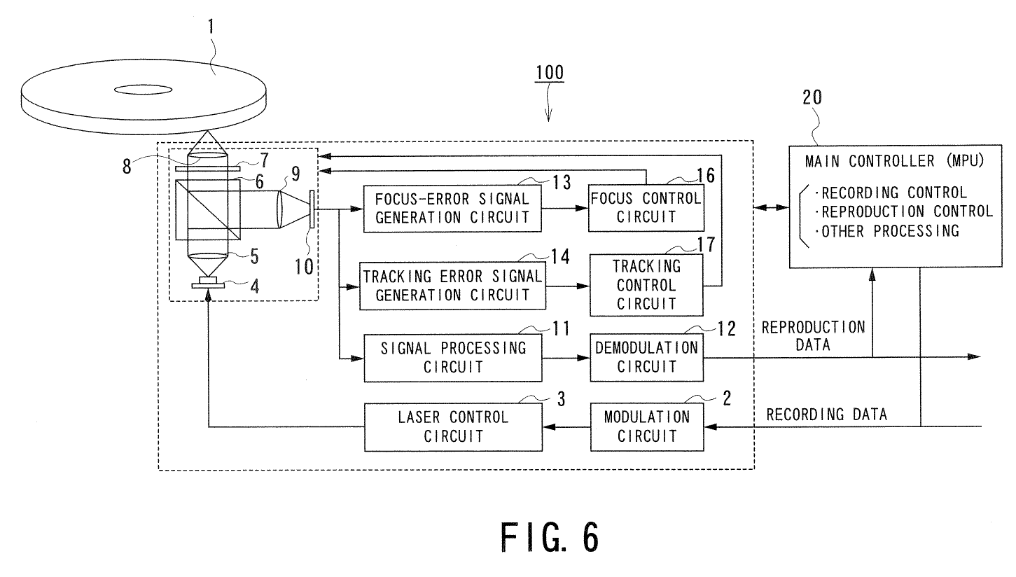

FIG. 6 is a diagram illustrating an example of the system configuration of the information recording/reproducing apparatus 100 according to an embodiment of the present invention.

The recording/reproducing apparatus 100 includes a modulation circuit 2, a laser control circuit 3, a laser 4, a collimating lens 5, a polarizing beam splitter (in the following, PBS) 6, a quarter wavelength plate 7, an objective lens 8, a condensing lens 9, a photo-detector 10, a signal processing circuit 11, a demodulation circuit 12, a focus-error signal generation circuit 13, a tracking error signal generation circuit 14, a focus-control circuit 16, a tracking control circuit 17, and a main controller 20.

The main controller 20 controls a drive section. The drive section includes the modulation circuit 2, the laser control circuit 3, the laser 4, the collimating lens 5, the PBS 6, the quarter wavelength plate 7, the objective lens 8, the condensing lens 9, the photo-detector 10, the signal processing circuit 11, the demodulation circuit 12, the focus-error signal generation circuit 13, the tracking error signal generation circuit 14, the focus-control circuit 16, and the tracking control circuit 17.

First, a description will be given of the recording of data and the drawing of an image by the information recording/reproducing apparatus 100. The recording of data is controlled by the main controller 20. The recording data (data symbol) is modulated to a predetermined channel-bit sequence by the modulation circuit 2. The channel-bit sequence corresponding to the recording data is converted into a laser-driven waveform by the laser control circuit 3. The laser control circuit 3 pulse drives the laser 4 to record the data corresponding to the predetermined channel-bit sequence on the information storage medium 1. The recording laser beam emitted from the laser 4 is collimated by the collimating lens 5, and enters into the PBS 6 to be transmitted. The beam that has been transmitted through the PBS 6 is transmitted through the quarter wavelength plate 7, and is condensed onto the information recording face (first recording layer 57) of the medium 1 by the objective lens 8. The condensed beam is maintained on the recording face (first recording layer 57) in a state of obtaining the best microscopic spot by the focus control based on the focus control circuit 16 and the tracking control based on the tracking control circuit 17.

The drawing an image on the second recording layer 54 is performed almost in the same manner as the recording of data. However, when an image is drawn, it is necessary to convert the pixel data of an image into an appropriate pit-pattern data to be drawn on the second recording layer 54 in advance. Also, the focus position by the focus control needs to be controlled so as to match the second recording layer 54.

Next, a description will be given of the data reproduction by this information recording/reproducing apparatus. The reproduction of data is controlled by the main controller 20. The laser 4 emits a reproduction laser beam on the basis of the data reproduction instruction from the main controller 20. The reproduction laser beam emitted from the laser 4 is collimated by the collimating lens 5, and enters into the PBS 6 to be transmitted. The light beam that has been transmitted through the PBS 6 is transmitted through the quarter wavelength plate 7, and is condensed onto the information recording face of the medium 1 by the objective lens 8. The condensed beam is maintained on the recording face in a state of obtaining the best microscopic spot by the focus control based on the focus control circuit 16 and the tracking control based on the tracking control circuit 17. At this time, the reproduction laser beam emitted on the medium 1 is reflected by a reflection film or a reflective recording film on the information recording face. The reflected light is transmitted through the objective lens 8 in the opposite direction, and is collimated again. The reflected light is transmitted through the quarter wavelength plate 7, is polarized in the direction perpendicular to the incident light, and thus is reflected by the PBS 6. The beam reflected by the PBS 6 is converged by the condensing lens 9, and enters into the photo-detector 10. The photo-detector 10 includes, for example four-divided photo detectors. The incident light on the photo-detector 10 is photo-electrically converted into an electric signal, and is amplified. The amplified signal is equalized and binarized by the signal processing circuit 11, and is sent to the demodulation circuit 12. The signal is subjected to a demodulation operation in accordance with the predetermined modulation method by the demodulation circuit 12, and the reproduction data is output.

Also, a focus error signal is generated by the focus-error signal generation circuit 13 on the basis of part of the electric signal output from the photo-detector 10. Similarly, a tracking error signal is generated by the tracking-error signal generation circuit 14 on the basis of part of the electric signal output from the photo-detector 10. The focus control circuit 16 controls the focus of the beam spot on the basis of the focus-error signal. The tracking control circuit 17 controls the tracking of the beam spot on the basis of the tracking-error signal.

Incidentally, the image drawn on the second recording layer 54 is intended to provide the user with a visual image, and is not directly related to the reproduction operation.

It is possible to optically form characters, images, etc., on the information storage medium with high visual distinguishability by the information storage medium 1, the information recording/reproducing apparatus 100, and the method of recording/reproducing information according to the present embodiment.

Each of the above-described embodiments of the present invention is not limited as it is. The present invention can be carried out in various ways by modifying components without departing from the spirit and the scope of the invention. Also, various inventions may be made by appropriately combining a plurality of the components disclosed in each of the above-described embodiments. For example, some components may be deleted from all the components shown in each embodiment. Furthermore, several components may be appropriately combined from all the components of different embodiments.

What is claimed is:

1. An information storage medium for allowing multilayer recording with a laser-emitted face on one side and a label face on the other side, the information storage medium comprising:
a first recording layer for optically recording various kinds of digital data from the laser-emitted face side; and
a second recording layer for optically recording image data from the laser-emitted face side and allowing visual confirmation from the label face side.

2. The information storage medium according to claim 1,
wherein the information storage medium has a transparent structure.

3. The information storage medium according to claim 1,
wherein the information storage medium is an information storage medium of a recordable type or a rewritable type, and
the various kinds of digital data and the image data are recordable or rewritable.

4. The information storage medium according to claim 1,
wherein the image data includes a character, and
the character is recorded in mirror writing from the laser-emitted face side.

5. The information storage medium according to claim 1,
wherein the information storage medium includes a plurality of the second recording layers, and grayscales of the image data can be expressed by the plurality of second recording layers.

6. The information storage medium according to claim 1,
wherein the information storage medium includes a plurality of the second recording layers, and a color of the image data can be expressed by the plurality of second recording layers.

7. An information recording/reproducing apparatus for recording and reproducing information onto and from an information storage medium allowing multilayer recording with a laser-emitted face on one side and a label face on the other side, the information recording/reproducing apparatus comprising:
means for optically recording and reproducing various kinds of digital data onto and from a first recording layer from the laser-emitted face side; and
means for optically recording image data onto a second recording layer from the laser-emitted face side and allowing visual confirmation from the label face side.

8. The information recording/reproducing apparatus according to claim 7,
wherein the information storage medium has a transparent structure.

9. The information recording/reproducing apparatus according to claim 7,
wherein the information storage medium is an information storage medium of a recordable type or a rewritable type, and
the various kinds of digital data and the image data are recordable or rewritable.

10. The information recording/reproducing apparatus according to claim 7,
wherein the image data includes a character, and
the character is recorded in mirror writing from the laser-emitted face side.

11. The information recording/reproducing apparatus according to claim 7,
wherein the information storage medium includes a plurality of the second recording layers, and grayscales of the image data can be expressed by the plurality of second recording layers.

12. The information recording/reproducing apparatus according to claim 7,
wherein the information storage medium includes a plurality of the second recording layers, and a color of the image data can be expressed by the plurality of second recording layers.

13. A method of recording onto and reproducing from an information storage medium allowing multilayer recording with a laser-emitted face on one side and a label face on the other side, the method comprising the steps of:
optically recording and reproducing various kinds of digital data onto and from a first recording layer from the laser-emitted face side; and
optically recording image data onto a second recording layer from the laser-emitted face side and allowing visual confirmation from the label face side.

14. The method of recording and reproducing according to claim 13,
wherein the information storage medium has a transparent structure.

15. The method of recording and reproducing according to claim 13,
wherein the information storage medium is an information storage medium of a recordable type or a rewritable type, and
the various kinds of digital data and the image data are recordable or rewritable.

16. The method of recording and reproducing according to claim 13,
wherein the image data includes a character, and
the character is recorded in mirror writing from the laser-emitted face side.

17. The method of recording and reproducing according to claim 13,
wherein the information storage medium includes a plurality of the second recording layers, and grayscales of the image data can be expressed by the plurality of second recording layers.

18. The method of recording and reproducing according to claim 13,
wherein the information storage medium includes a plurality of the second recording layers, and a color of the image data can be expressed by the plurality of second recording layers.
